(19) United States
(12) Patent Application Publication
(10) Pub. No.: US 2023/0140373 A1
(43) Pub. Date: May 4, 2023

(54) Ultra-Thin Glass Comprising Coating Layer, and Method for Manufacturing the Same

(71) Applicant: DONGWOO FINE-CHEM CO., LTD., Jeollabuk-do (KR)

(72) Inventors: Seung-June Park, Gyeonggi-do (KR); Jong-Min Kim, Gyeonggi-do (KR); Joon-Ha Park, Gyeonggi-do (KR); Gyeong-Min Seok, Gyeonggi-do (KR); Jae-Woo Jeong, Gyeonggi-do (KR)

(73) Assignee: DONGWOO FINE-CHEM CO., LTD., Jeollabuk-do (KR)

(21) Appl. No.: 17/980,258

(22) Filed: Nov. 3, 2022

(30) Foreign Application Priority Data
Nov. 4, 2021 (KR) 10-2021-0150310
Oct. 26, 2022 (KR) 10-2022-0139299

(51) Int. Cl. C03C 17/00

(52) U.S. Cl. CPC C03C 17/002; C03C 2217/78

(57) ABSTRACT

The present disclosure relates to an ultrathin glass comprising a coating layer, wherein the coating layer comprises a top surface coating layer formed on the top surface of the ultrathin glass and a side surface coating layer that is connected to the top surface coating layer and covers the side surface of the ultrathin glass, and a method for preparing the same.

### TECHNICAL FIELD

The present disclosure relates to an ultrathin glass comprising a coating layer and a method for preparing the same.

### BACKGROUND ART

With the recent development of display technology, a foldable display, a rollable display, a stretchable display, etc. are being developed, and in order to protect these various types of displays, research on an ultrathin glass with improved flexible properties is being actively conducted.

This ultrathin glass has flexible properties so that excellent flexural strength is required in order to be used in various types of displays, and improvement of surface roughness is required to improve display quality.

In general, in order to reduce the possibility of scratching the glass surface of the window glass when using the display and the possibility of breakage due to dropping during use, the window glass used in the mobile display uses ion substitution chemical strengthening to improve the strength.

Usually, a process of laminating functional layers such as a hard coating layer, an anti-shattering layer, an impact-resistant layer, and an anti-fingerprint layer on the ultrathin glass using a pressure-sensitive adhesive during the preparation of an ultrathin glass is in progress. However, when using the mobile display manufactured in this way, pen marks, scratches, and the like occur while continuously using a notebook or pen, and there have been problems such as a rolling property problem and poor appearance.

Korean Patent No. 10-2210663 discloses a method for preparing a UTFG for foldable phones, which is implemented such that a UTFG (Ultrathin Foldable Glass) for foldable phones may be prepared by increasing the impact resistance like that of glass pen drop, and the folding strength. However, there has been a problem in that the coating layer formed on the ultrathin glass had poor display quality or lowered uniformity due to defects and coating layer breakage caused by the flow of a coating solution on the side surface of the ultrathin glass and contamination on the rear surface thereof that may still occur in the coating process.

Therefore, there is a need to develop an ultrathin glass comprising a coating layer, which satisfies the required performance while preventing defects and damage to the coating layer occurring when the coating layer is formed on the ultrathin glass.

### PRIOR ART DOCUMENT

### Patent Document

Korean Patent No. 10-2210663

### DISCLOSURE

### Technical Problem

The present disclosure is to improve the problems of the conventional art described above, and an object of the present disclosure is to provide an ultrathin glass comprising a coating layer, which is capable of preventing defects and damage to the coating layer occurring when the coating layer is formed on the ultrathin glass, and a method for preparing the same.

Another object of the present disclosure is to provide an ultrathin glass comprising a coating layer, which can protect not only the top surface of the ultrathin glass, but also the side surface thereof, and a method for preparing the same.

Still another object of the present disclosure is to provide an ultrathin glass comprising a coating layer, which has excellent uniformity and display quality of a coating layer formed on the ultrathin glass, and a method for preparing the same.

However, the problems to be solved by the present disclosure are not limited to the problems mentioned above, and other problems not mentioned will be clearly understood by those skilled in the art from the following description.

### Technical Solution

In order to achieve the above objects, the present disclosure provides an ultrathin glass comprising a coating layer, wherein the coating layer comprises a top surface coating layer formed on the top surface of the ultrathin glass and a side surface coating layer that is connected to the top surface coating layer and covers the side surface of the ultrathin glass.

Furthermore, the present disclosure provides a method for preparing an ultrathin glass comprising a coating layer, the method comprising the steps of: (a) attaching an ultrathin glass on a first protective film; (b) attaching a second protective film on the first protective film to which the ultrathin glass has been attached; (c) cutting the second protective film attached on the first protective film; (d) peeling off the second protective film on the top portion of the ultrathin glass; (e) forming a coating layer by applying and curing a composition for forming a coating layer on the ultrathin glass from which the second protective film has been peeled off; and (f) peeling off the first protective film from the ultrathin glass.

### Advantageous Effects

According to the ultrathin glass comprising a coating layer according to the present disclosure and the method for preparing the same, it is possible to prevent defects and damage to the coating layer when the coating layer is formed on the ultrathin glass.

Further, according to the ultrathin glass comprising a coating layer according to the present disclosure and the method for preparing the same, it is possible to protect not only the top surface of the ultrathin glass, but also the side surface thereof.

Further, according to the ultrathin glass comprising a coating layer according to the present disclosure and the method for preparing the same, it is possible to provide an ultrathin glass with high reliability due to excellent uniformity and display quality of the coating layer.

### DESCRIPTION OF DRAWINGS

FIG. 1 is a view showing a laminated structure of an ultrathin glass comprising a coating layer according to one embodiment of the present disclosure.

FIG. 2 is a view showing a method for preparing an ultrathin glass comprising a coating layer according to one embodiment of the present disclosure.

### BEST MODE FOR CARRYING OUT THE INVENTION

The present disclosure relates to an ultrathin glass comprising a coating layer and a method for preparing the same, and more particularly, to an ultrathin glass comprising a coating layer, wherein the coating layer comprises a top surface coating layer formed on the top surface of the ultrathin glass and a side surface coating layer that is connected to the top surface coating layer and covers the side surface of the ultrathin glass.

Furthermore, the present disclosure relates to a method for preparing an ultrathin glass comprising a coating layer, the method comprising the steps of: (a) attaching an ultrathin glass on a first protective film; (b) attaching a second protective film on the first protective film to which the ultrathin glass has been attached; (c) cutting the second protective film attached on the first protective film; (d) peeling off the second protective film on the top portion of the ultrathin glass; (e) forming a coating layer by applying and curing a composition for forming a coating layer on the ultrathin glass from which the second protective film has been peeled off; and (f) peeling off the first protective film from the ultrathin glass.

Hereinafter, embodiments of the present disclosure will be described in more detail with reference to the drawings. However, the following drawings attached to the present specification illustrate preferred embodiments of the present disclosure, and play a role of allowing the technical idea of the present disclosure together with the above-described contents of the invention to be further understood. Therefore, the present disclosure should not be construed as being limited only to the matters described in such drawings.

The terminology used in the present specification is for the purpose of describing the embodiments, and is not intended to limit the present disclosure. In the present specification, the singular form also comprises the plural form unless specifically stated otherwise in the phrase.

The term “comprises” and/or “comprising” used in the present specification is used in the sense that it does not exclude the presence or addition of one or more other components, steps, operations and/or elements other than the stated component, step, operation and/or element. The same reference numerals refer to the same components throughout the specification.

Spatially relative terms ^{┌}below_{┘}, ^{┌}bottom surface_{┘}, ^{┌}bottom portion_{┘}, ^{┌}above_{┘}, ^{┌}top surface_{┘}, ^{┌}top portion_{┘}, etc. may be used to easily describe correlations of one element or components with another element or components as shown in the drawings. The spatially relative terms should be understood as terms comprising different directions of components during use or operation in addition to the directions shown in the drawings. For example, when a component or a laminate shown in the drawings is turned over, a component described as being ^{┌}below_{┘} or ^{┌}bottom portion of_{┘} other component may be put ^{┌}above_{┘} the other component. Accordingly, the exemplary term ^{┌}below_{┘} may comprise both the below and above directions. Components may also be oriented in other directions, and thus the spatially relative terms may be interpreted according to the orientation.

The ^{┌}vertical direction_{┘} used in the present specification may be interpreted as a direction in which each of the components is laminated, that is, a thickness direction of each of the components, and the ^{┌}horizontal direction_{┘} may be interpreted as a direction orthogonal to a direction in which each of the components is laminated, that is, the longitudinal direction of each of the components.

<Ultrathin Glass Comprising Coating Layer>

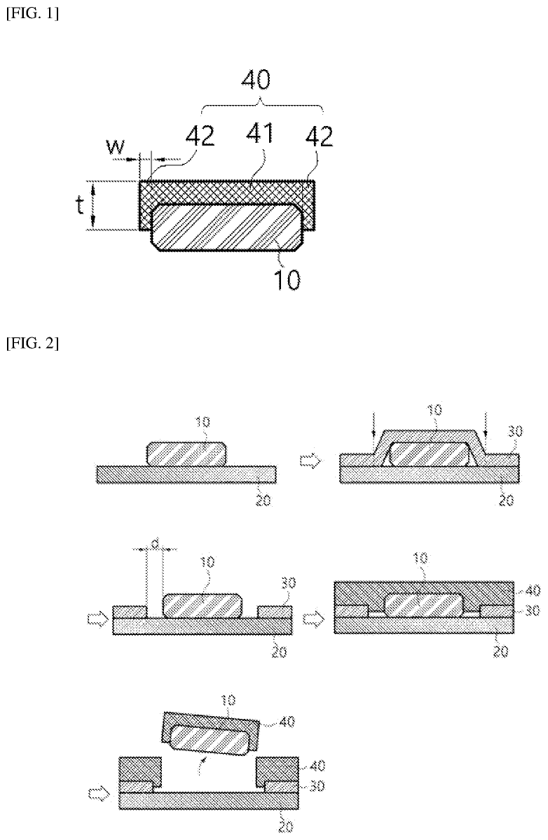

FIG. 1 is a view showing a laminated structure of an ultrathin glass comprising a coating layer according to one embodiment of the present disclosure.

The ultrathin glass comprising a coating layer according to the present disclosure comprises an ultrathin glass 10 and a coating layer 40, and the coating layer 40 comprises a top surface coating layer 41 and a side surface coating layer 42.

Ultrathin Glass

The ultrathin glass 10 according to the present disclosure is a circular plate cut in cell units, and the cut surface thereof, that is, the side surface of the ultrathin glass 10 may have a vertical shape without bending, and may be polished to have a constant side surface roughness. In the ultrathin glass 10 polished as described above, an edge portion may be formed at a portion where the top surface and the side surface are connected due to the polished portion. The edge portion may be an inclined or curved surface, and may be prepared by a method for preparing an ultrathin glass to be described later, but is not limited thereto.

The ultrathin glass 10 may have a thickness of 20 to 150 μm.

The ultrathin glass 10 may comprise one or more selected from the group consisting of alumino-borosilicate, borosilicate, alkali lead silicate, soda lime, lithium aluminosilicate, and aluminosilicate, preferably one or more selected from the group consisting of soda lime, lithium aluminosilicate, and aluminosilicate.

Coating Layer

The coating layer 40 comprises a top surface coating layer 41 which may be formed by applying and curing a composition for forming a coating layer on the ultrathin glass 10, and which is formed on the top surface of the ultrathin glass 10, and a side surface coating layer 42 which is connected to the top surface coating layer 41 and covers the side surface of the ultrathin glass 10.

Specifically, the top surface coating layer 41 means a portion coated on the top surface of the ultrathin glass 10, and comprises a coating layer formed on the edge portion of the top surface end of the ultrathin glass 10 when an edge portion is present at the end of the ultrathin glass 10.

The side surface coating layer 42 means a portion coated on the side surface of the ultrathin glass 10, and means a portion which is formed by covering all or a part of the side surface of the ultrathin glass 10 while it is being connected from the top surface coating layer 41. At this time, the side surface coating layer 42 may be formed while covering all or a part of both side surfaces of the ultrathin glass 10.

In the present specification, the ^{┌}top surface_{┘} of the side surface coating layer 42 represents a surface parallel to the ^{┌}top surface_{┘} of the ultrathin glass 10, the ^{┌}bottom surface_{┘} of the side surface coating layer 42 represents the other surface at the opposite side of the ^{┌}top surface_{┘} of the side surface coating layer 42, and the ^{┌}side surface_{┘} of the side surface coating layer 42 represents a surface parallel to the ^{┌}side surface_{┘} of the ultrathin glass 10.

The side surface coating layer 42 may be formed to be spaced apart by a predetermined height from the lower end of the side surface of the ultrathin glass 10 in order to prevent defects that occur while the composition for forming a coating layer flows into the rear surface of the ultrathin glass 10.

A predetermined height by which the side surface coating layer 42 is spaced apart from the lower end of the side surface of the ultrathin glass 10 is preferably within 10% of the thickness of the ultrathin glass such that the side surface of the ultrathin glass 10 is protected without the composition for forming a coating layer flowing into the rear surface of the ultrathin glass 10.

The side surface coating layer 42 may have a width w of 230 μm or less, preferably 30 to 200 μm. Here, the width w of the side surface coating layer 42 means a distance obtained by measuring in the horizontal direction a distance between the side surface of the ultrathin glass 10 and the side surface of the side surface coating layer 42, and may be expressed as an average value of values obtained by performing measurement multiple times. When the width w of the side surface coating layer 42 satisfies the above numerical range, there is an advantage in that the side surface of the ultrathin glass 10 may be protected while maintaining the display quality of the coating layer 40.

Meanwhile, the width w of the side surface coating layer 42 may have a difference between maximum and minimum values of 100 μm or less. The side surface of the coating layer 40 may be uniformly maintained by minimizing the deviation of the width w of the side surface coating layer 42 to satisfy the above range.

The side surface coating layer 42 may have a thickness t of 300 μm or less, preferably 30 to 250 μm. Here, the thickness t of the side surface coating layer 42 means a distance obtained by measuring in the vertical direction a distance between the bottom surface and the top surface of the side surface coating layer 42. When the thickness t of the side surface coating layer 42 does not satisfy the above range, there may occur a problem in the hardness and durability of the coated ultrathin glass 10, there may be a problem in the curability of the coating layer 40, or cracks may occur.

The top surface coating layer 41 preferably has a thickness of 5 to 150 μm. Here, the thickness of the top surface coating layer 41 means a distance obtained by measuring in the vertical direction a distance between the surface in contact with the ultrathin glass 10 and the top surface of the top surface coating layer 41.

When the top surface coating layer 41 has a thickness of less than 5 μm, physical properties such as hardness and durability of the coated ultrathin glass 10 may decrease, and when the top surface coating layer 41 has a thickness exceeding 150 μm, the curability of the coating layer 40 may be poor, cracks may occur, and there is a concern that the preparation cost may increase.

The composition for forming a coating layer may be used without limitation as long as it can satisfy the physical properties listed above, and may comprise, for example, an epoxy-based silane compound, a (meth)acrylate having an alicyclic structure, a 2-(unsaturated alkoxyalkyl)acrylate, an epoxy compound having an alicyclic structure, an epoxy-based ether compound, and an oxetane compound.

The epoxy-based silane compound is a component for improving the adhesion of the coating layer, and specific examples thereof may comprise 3-glycidoxypropyl-trimethoxysilane(γ-glycidoxypropyl-trimethoxysilane), 3-glycidoxypropyl-methyldimethoxysilane, 3-glycidoxypropyl-triethoxysilane, 3-glycidoxypropyl-methyldiethoxysilane, β-(3,4-epoxycyclohexyl)ethyl-trimethoxysilane, etc.

The (meth)acrylate having an alicyclic structure is a component for adjusting the elastic modulus of the coating layer, and specific examples thereof may comprise (meth)acrylic acid isobornyl, (meth)acrylic acid cyclohexyl, (meth)acrylic acid dicyclopentanyl, (meth)acrylic acid cyclododecyl, (meth)acrylic acid methylcyclohexyl, (meth)acrylic acid trimethylcyclohexyl, (meth)acrylic acid tert-butylcyclohexyl, α-ethoxy (meth)acrylic acid cyclohexyl, (meth)acrylic acid cyclohexylphenyl, etc.

The 2-(unsaturated alkoxyalkyl)acrylate is a component for improving the adhesion of the coating layer, and specific examples thereof may comprise 2-allyloxymethyl acrylic acid, 2-allyloxymethyl acrylic acid methyl, 2-allyloxymethyl acrylic acid ethyl, 2-allyloxymethyl acrylic acid n-propyl, 2-allyloxymethyl acrylic acid i-propyl, 2-allyloxymethyl acrylic acid n-butyl, 2-allyloxymethyl acrylic acid s-butyl, 2-allyloxymethyl acrylic acid t-butyl, 2-allyloxymethyl acrylic acid n-amyl, 2-allyloxymethyl acrylic acid s-amyl, 2-allyloxymethyl acrylic acid t-amyl, 2-allyloxymethyl acrylic acid neopentyl, etc.

The epoxy compound having an alicyclic structure is a component for forming a base matrix of the coating layer, and specific examples thereof may comprise 3,4-epoxycyclohexylmethyl 3,4-epoxycyclohexanecarboxylate, 1,2-epoxy-4-vinylcyclohexane, 1,2-epoxy-1-methyl-4-(1-methylepoxyethyl)cyclohexane, 3,4-epoxycyclohexylmethyl methacrylate, a 4-(1,2-epoxyethyl)-1,2-epoxycyclohexane adduct of 2,2-bis(hydroxymethyl)-1-butanol, ethylene bis(3,4-epoxycyclohexanecarboxylate), oxydiethylene bis(3,4-epoxycyclohexanecarboxylate), 1,4-cyclohexanedimethyl bis(3,4-epoxycyclohexanecarboxylate), 3-(3,4-epoxycyclohexylmethoxycarbonyl)propyl3,4-epoxycyclohexanecarboxylate, etc.

The epoxy-based ether compound is a component for adding flexibility to the coating layer, and specific examples thereof may comprise 1,4-cyclohexanedimethanol diglycidyl ether, 1,4-butanediol diglycidyl ether, 1,6-hexanediol diglycidyl ether, neopentyl diglycidyl ether, resorcinol diglycidyl ether, diethylene glycol diglycidyl ether, ethylene glycol diglycidyl ether, trimethylolpropane triglycidyl ether, n-butyl glycidyl ether, 2-ethylhexyl glycidyl ether, phenyl glycidyl ether, o-cresyl glycidyl ether, etc.

The oxetane compound is a component for adjusting the viscosity of the composition for forming a coating layer, and specific examples thereof may comprise 3-ethyl-3-hydroxymethyloxetane, 3-ethyl-3-(3-hydroxypropyl)oxymethyloxetane, 3-ethyl-3-(4-hydroxybutyl)oxymethyloxetane, 3-ethyl-3-(5-hydroxypentyl)oxymethyloxetane, 3-ethyl-3-phenoxymethyloxetane, bis((1-ethyl(3-oxetanyl)methyl)ether, 3-ethyl-3-((2-ethylhexyloxy)methyl)oxetane, 3-ethyl-((triethoxysilylpropoxymethyl)oxetane, 3-(meth)allyloxymethyl-3-ethyloxetane, 3-hydroxymethyl-3-ethyloxetane, etc.

The composition for forming a coating layer according to one embodiment of the present disclosure may comprise 10 to 40% by weight of an epoxy-based silane compound, 0.1 to 20% by weight of a (meth)acrylate having an alicyclic structure, 1 to 30% by weight of a 2-(unsaturated alkoxyalkyl) acrylate, 10 to 40% by weight of an epoxy compound having an alicyclic structure, 10 to 40% by weight of an epoxy-based ether compound, and 0.1 to 20% by weight of an oxetane compound based on the total weight of the composition. When the composition for forming a coating layer satisfies the above content range, it is preferable since adhesion, elastic modulus, flexibility, and the like of the coating layer can be improved.

<Method for Preparing Ultrathin Glass Comprising Coating Layer>

FIG. 2 is a view showing a method for preparing an ultrathin glass comprising a coating layer according to one embodiment of the present disclosure.

A method for preparing an ultrathin glass comprising a coating layer according to one embodiment of the present disclosure comprises the steps of: (a) attaching an ultrathin glass on a first protective film; (b) attaching a second protective film on the first protective film to which the ultrathin glass has been attached; (c) cutting the second protective film attached on the first protective film; (d) peeling off the second protective film on the top portion of the ultrathin glass; (e) forming a coating layer by applying and curing a composition for forming a coating layer on the ultrathin glass from which the second protective film has been peeled off; and (f) peeling off the first protective film from the ultrathin glass.

(a) Attaching an Ultrathin Glass on a First Protective Film

First, an ultrathin glass 10 is attached on a first protective film 20.

The first protective film 20 blocks the inflow of contaminants to the rear surface of the ultrathin glass 10 or controls the shape of the coating layer when the coating layer 40 is formed, and serves as a support layer for the ultrathin glass 10.

The first protective film 20 may be selected from polyethylene terephthalate (PET), polyethylene (PE), polyurethane (PU), and the like, but is not limited thereto.

The first protective film 20 may be attached to the ultrathin glass 10 through a pressure-sensitive adhesive, but is not limited thereto. The first protective film 20 may have a thickness of 20 to 210 μm, and the thickness is a thickness comprising the thickness of the pressure-sensitive adhesive when the first protective film 20 is attached to the ultrathin glass 10 through a pressure-sensitive adhesive.

When the thickness of the first protective film 20 satisfies the above numerical range, the folding or the like of the film is suppressed with respect to conveyance and transport in the process after the coating process of the ultrathin glass 10 so that the handling properties are excellent.

Specific details of the ultrathin glass 10 are the same as those described in the ultrathin glass comprising a coating layer.

(b) Attaching a Second Protective Film on the First Protective Film to Which the Ultrathin Glass Has Been Attached

A second protective film 30 is attached on the first protective film 20 to which the ultrathin glass 10 has been attached in the step (a). That is, the second protective film 30 is attached on a first protective film 20 to which the ultrathin glass 10 has not been attached, and the top surface of the ultrathin glass 10.

The second protective film 30 may be selected from polyethylene terephthalate (PET), polyethylene (PE), polyurethane (PU), and the like, but is not limited thereto.

The second protective film 30 may be attached to the ultrathin glass 10 through a pressure-sensitive adhesive, but is not limited thereto.

At this time, the thickness of the second protective film 30 may be 30 to 140% of the thickness of the ultrathin glass 10, preferably 35 to 135%. That is, the second protective film 30 may have a thickness of 6 to 210 μm, preferably 7 to 200 μm. The thickness is a thickness comprising the thickness of the pressure-sensitive adhesive when the second protective film 30 is attached to the ultrathin glass 10 through the pressure-sensitive adhesive.

Thereafter, the second protective film 30 is cut through the step (c) described below, a portion on the top portion of the ultrathin glass 10 is peeled off in the step (d) described below, and then a coating layer 40 is formed on a portion on the top portion of the ultrathin glass 10, where the second protective film 30 has been peeled off. In addition, the second protective film 30 remains on the first protective film 20 to which the ultrathin glass 10 has not been attached, and the second protective film 30 remaining on the first protective film 20 serves to control the shape of the coating layer 40. Therefore, it is preferable to satisfy the above thickness ratio so that the shape of the coating layer 40 is efficiently controlled, and defects do not occur. When the thickness ratio of the second protective film 30 to the ultrathin glass 10 is out of the above range, a step is generated between the ultrathin glass 10 and the second protective film 30, so that bubbles may be generated in the coating layer 40.

(c) Cutting the Second Protective Film Attached on the First Protective Film

The second protective film 30 is cut in a state that it is spaced apart from the ultrathin glass 10 at a predetermined interval.

The separation distance d between the side surface of the ultrathin glass 10 and the cut surface of the second protective film may be 250 μm or less, preferably 30 to 200 μm. If it is out of the above numerical range, beads of the coating are unstably formed as the exposed area of a portion of the first protective film 20 to which the ultrathin glass 10 has not been attached is widened when the coating layer 40 is formed afterwards, so that a coating defect or the like may occur, or it may be difficult to control the specifications of the side surface coating layer, the coating solution may flow into the rear surface of the ultrathin glass 10, and defects may occur due to this.

The cutting may be done through laser processing, and as the laser, CO₂ Laser, UV Laser, Pico Laser, etc. may be used, and Rep/Rate 50 KHZ, Duty 5%, Power 1.64 W 2 Pass, etc. may be used, but are not limited thereto.

(d) Peeling Off the Second Protective Film on the Top Portion of the Ultrathin Glass

As a step of peeling off the second protective film cut in the step (c), the portion attached on the top surface of the ultrathin glass 10 is peeled off.

At this time, peeling may be performed by a method of peeling off the second protective film 30 by passing the cut second protective film 30 through an adhesive roller or a method of peeling off the protective film by picking-up the protective film by mechanical equipment, but is not limited thereto.

(e) Forming a Coating Layer on the Ultrathin Glass

After the step (d), the coating layer 40 is formed by applying and curing the composition for forming a coating layer on the ultrathin glass 10 from which the second protective film 30 has been peeled off.

The composition for forming a coating layer is applied over the second protective film 30 and the ultrathin glass 10 that remain after being cut and peeled off, and the coating layer 40 is formed through a curing process. The coating layer 40 comprises a top surface coating layer 41 formed on the top surface of the ultrathin glass 10 and a side surface coating layer 42 which is connected to the top surface coating layer 41, and covers all or a part of the side surface of the ultrathin glass 10.

A method for applying and coating a coating layer forming composition for forming the coating layer 40 is not limited to any specific method, and those skilled in the art may arbitrarily select and apply it among known coating methods such as bar coating, slit coating, dip coating, roll coating, spin coating, spray coating, immersion method, impregnation method, gravure coating, and the like.

The composition for forming a coating layer may be cured by thermal curing or UV irradiation after being applied. The coating process may be performed at a temperature condition of 60 to 200° C. during thermal curing, and when a UV-curable coating solution is used, the coating process may be performed within an ultraviolet wavelength range of 254 to 400 nm.

In one embodiment, the coating layer may be irradiated with ultraviolet rays under general atmospheric conditions. In the present step, the coating layer may be irradiated with ultraviolet rays at a light quantity of 400 to 500 mJ/cm² using an ultraviolet irradiation device (e.g., a mercury lamp). When the light quantity during UV irradiation is less than 400 mJ/cm², the curability is not good, and when it exceeds 500 mJ/cm², as the curing proceeds excessively, there are concerns that the elongation of the coating layer 40 may be lowered, and a crack phenomenon may occur in the coating layer 40. It is more preferable to irradiate the coating layer 40 with ultraviolet rays in a light quantity of 500 mJ/cm² in terms of maintaining the physical properties of the cured coating layer 40 at an excellent level.

The UV irradiation time during the UV irradiation is not particularly limited, and may be selected within an appropriate time range so that the coating layer 40 can be sufficiently cured.

Meanwhile, specific contents, such as the components, thickness, and the like of the coating layer 40 comprising the top surface coating layer 41 and the side surface coating layer 42, and the composition for forming a coating layer, are the same as those described in the ultrathin glass comprising the coating layer.

(f) Peeling Off the First Protective Film from the Ultrathin Glass

The first protective film 20 is peeled off from the ultrathin glass 10 comprising the coating layer 40 formed in the step (e).

The step (f) is a step in which, after the coating process on the ultrathin glass 10 is finished, the first protective film 20 attached to the bottom surface of the ultrathin glass 10 is peeled off and removed, and the first protective film 20 may be peeled off well without damage to the ultrathin glass 10 after all the processes are completed.

Meanwhile, the method may further comprise a step of cutting the side surface of the coating layer 40 formed in the step (e), between the steps (e) and (f).

That is, the coating layer 40 formed in the step (e) may be cut to have a certain width w, and specifically, it may be cut so that the width w from the side end of the ultrathin glass 10 to the cut surface of the coating layer 40 becomes 230 μm or less, preferably 30 to 200 μm.

At this time, the width w of the side surface coating layer 42 to be cut may have a difference between the maximum value and the minimum value of 100 μm or less.

In the case of cutting the side surface of the coating layer 40 in this way, damage to the coating layer 40 may be prevented in the process of removing the first protective film 20 in the step (f), and the difference between the maximum value and the minimum value of the width w of the side surface coating layer 42 may satisfy the above numerical range, and in this case, there is an advantage in that the display quality of the coating layer 40 can be improved since the side surface of the coating layer 40 may be maintained uniformly.

The cutting may be done through laser processing, and as the laser, CO₂ Laser, UV Laser, Pico Laser, etc. may be used, and Rep/Rate 50 KHZ, Duty 5%, Power 1.64 W 2 Pass, etc. may be used, but are not limited thereto.

Thereafter, a functional layer may be additionally formed on the bottom surface of the ultrathin glass 10 or on the coating layer 40, and the functional layer may be a hard coating layer, an anti-shattering layer, an impact-resistant layer, an anti-fingerprint layer, or the like, but is not limited thereto.

<Method for Preparing Ultrathin Glass>

Hereinafter, a method for preparing an ultrathin glass, which can be performed before the step of forming a pressure-sensitive adhesive layer on the base layer of the ultrathin glass according to the present disclosure will be described in detail.

The method for preparing an ultrathin glass according to the present disclosure may comprise steps of: preparing a plurality of cells by cutting an original glass in cell units; polishing the cut surface of the cell; and etching the polished cell and healing the polished cut surface of the cell, and may further comprise steps of performing cleaning; performing chemical strengthening; and/or performing chemical polishing, after the step of performing healing.

Cutting the Original Glass in Cell Units

First, a plurality of cells are prepared by cutting the original glass in cell units.

The step of cutting the original glass in cell units is a step for forming a shape in accordance with the design of a device for which the original glass is to be used, and may be to form a plurality of cells by cutting the original glass. The present step may be a step performed without stacking the original glass in a plurality of layers. This enables cell tracking when defects occur, simplifies the preparation process by omitting the lamination process, reduces the defect rate for residues that may be generated during the lamination process, and has an advantage that the shape of the glass side surface can be freely selected.

The cutting step is not particularly limited as long as it is a step in which a plurality of cells can be formed by cutting the original glass, and in one embodiment, the cutting step may be to form a plurality of cells showing a certain shape using a diamond cutting wheel or a laser-mounted CNC cutting machine.

Polishing the Cut Surface of the Unit Cell

Subsequently, the method for preparing an ultrathin glass according to the present disclosure comprises a step of polishing the cut surface of the cell, and the polishing is preferably physical polishing, and most preferably, the cut surface of the cell may be physically polished so that the cut surface of the cell has a round shape. The cut surface of the cell means a side surface of the cell. At this time, the thickness of the cut cell may be the same as the thickness of the original glass.

The physical polishing step comprises physically polishing chipping of the cut surface after the cutting step and processing the cell side surface into a desired shape at the same time. At this time, the thickness of the cut cell may be the same as the thickness of the original glass before cutting.

The polished cut surface, that is, the side surface of the cell, may have a gentle round shape having a predetermined curvature in stability terms of lowering the possibility of breakage during a post-process.

The physical polishing step is not particularly limited as long as it is a method capable of physically polishing chipping generated during cutting, and in one embodiment, it may be performed by comprising: a roughing step of polishing the cut surface of the cut cell using a chamfering tool of 400 meshes or less; a semi-finishing step of polishing the cut surface of the cell that has undergone the roughing step using a chamfering tool of about 500 to 800 meshes; and a finishing step of polishing the cross section of the cell that has undergone the semi-finishing step using a chamfering tool of 1,200 meshes or more.

Etching the Polished Cell and Healing the Polished Cut Surface of the Polished Cell

Subsequently, the method for preparing an ultrathin glass according to the present disclosure may comprise a step of etching the polished cell and healing the polished cut surface of the polished cell. The above step of the present disclosure comprises performing a step of etching the polished cell and a step of healing the polished cut surface of the polished cell at the same time. In addition, the healed cut surface refers to the side surface of an ultrathin glass cell that is finally prepared.

In the healing step of the present disclosure, the polished cell may be etched without a protective material, such as resin or film, for preventing impact on the glass during the process or masking the etchant.

An ultrathin glass in a cell unit may be obtained by making the polished cell ultrathin through a chemical etching process, and healing the polished cut surface of the cell at the same time.

Specifically, the etching step of the polished cell comprises chemical etching, but is not limited thereto. The cell may be made ultrathin through the etching step of the polished cell. The ultrathinning refers to a process of making the glass thin to a thickness of 100 μm or less.

Although the step of etching the polished cell and the step of healing the polished cut surface of the polished cell may be performed separately, it is more preferable in terms of simplification of the process to perform the step of healing the cut surface of the polished cell and the step of etching the polished cell simultaneously by the same method.

When the etching and healing steps of the present disclosure are simultaneously performed, they are performed to make a cell in the thick-film state ultrathin and improve the edge strength of the cut cell at the same time, and the healed cut surface may be one which is processed into a smoother round shape than the shape of the polished cut surface. The cut surface defects such as chipping and the like of the cut surface due to physical polishing are removed by healing and the roughness is lowered so that destruction due to bending may be suppressed. It is preferable that the surface processed to the round shape forms a gentle curve.

In the chemical etching step, a dipping method of dipping a cell in an etchant may be used, and in one embodiment, the chemical etching step may be performed by comprising one or more of a cell jig fixing step of fixing the cell to a jig for handling the cell; a jig dipping step of dipping the jig in an etchant bath filled with an etchant so that the cell may be dipped in the etchant; a chemical etching step of uniformly chemically etching the thickness and the cut surface of the cell at a constant etching rate in a dipped state; a jig discharging step of discharging the jig from the etchant bath when chemical etching is completed; and a cell separation step of separating the cell that has completed chemical etching from the jig.

In addition to the dipping method in which the cell is fully immersed in the etchant, a side spray method or a top spray method may be additionally performed to help the etching.

Without the dipping method in which the cell is fully immersed in the etchant, only the side spray method or the top spray method may be performed. At this time, since the glass is cut in cell units, and thus the etchant may be adsorbed to the surface of the glass cell by the surface tension of the sprayed etchant, etching and side surface healing are possible.

In the etching and healing steps of the present disclosure, the contact between the respective glass cells may be minimized by performing etching and healing while moving a plurality of glass cells through the upper and lower jigs, respectively.

In one or more embodiments, the etchant may comprise one or more selected from the group consisting of hydrofluoric acid (HF), ammonium fluoride (NH₄F), ammonium hydrogen fluoride (NH₄HF₂), sodium fluoride (NaF), sodium hydrogen fluoride (NaHF₂), lithium fluoride (LiF), potassium fluoride (KF), calcium fluoride (CaF₂), and the like.

When the step of etching the polished cell and healing the polished cut surface of the polished cell is performed as separate steps, respectively, the step of healing the polished cut surface of the polished cell may be further performed by applying the same method as the above-described chemical etching step after etching the cell through the chemical etching step as described above.

Performing Cleaning, Chemical Strengthening, and/or Chemical Polishing

Further, the method for preparing an ultrathin glass according to the present disclosure may further comprise a step of performing cleaning, a step of performing chemical strengthening, and/or a step of performing chemical polishing. The cleaning step, the chemical strengthening step, and the chemical polishing step may have changed orders, may be added, or may be omitted as necessary.

The cleaning step may be one for removing residual foreign substances and etchant remained from the previous process. The cleaning process for removing the residual foreign substances and etchant may be one in which a commonly used process is used, and in one embodiment, a spray method of performing cleaning using a washing solution and spraying the washing solution or a dipping method of performing immersion in the washing solution may be used.

The washing solution is not particularly limited as long as it serves to clean the ultrathin glass surface, and in one or more embodiments, it may be deionized water (DI water), or an alkaline washing solution containing potassium hydroxide (KOH) or sodium hydroxide (NaOH).

The chemical strengthening step is one for strengthening the ultrathin glass by immersing the ultrathin glass in a molten salt and exchanging alkali ions in the ultrathin glass with alkali ions in the molten salt. In one embodiment, the chemical strengthening step may be performed by comprising: a preheating step of gradually raising the temperature of the ultrathin glass; a step of chemically strengthening the preheated ultrathin glass by ion substitution; and a step of slowly cooling the strengthened ultrathin glass at room temperature.

In order to prevent damage due to the rapid temperature change of the ultrathin glass in the chemical strengthening step proceeding at a high temperature of 350 to 500° C., the preheating step of gradually raising the temperature of the ultrathin glass may be performed to gradually raise the temperature thereof before immersing the ultrathin glass in the ion replacement solution.

In the chemical strengthening step, when a glass containing Na⁺ is brought into contact with a salt containing K⁺ ions, Na⁺ and K⁺ ion exchange on the surface proceeds in an inward direction, and in this case, K⁺ ions enter the position occupied by Na in the ultrathin glass structure. Since the ionic radius of K⁺ is larger than the ionic radius of Na⁺, a compressive force is generated around the network structure, which may strengthen the glass.

The depth at which K⁺ ions are substituted by the chemical strengthening is not particularly limited, but may be a depth of 5% to 40% of the cell thickness in terms of improving bending resistance, and specifically, preferably 10% to 35%, and more preferably 15% to 30%.

Further, the target depth of chemical strengthening may vary depending on the thickness of the glass, and for example, the depth (thickness) of chemical strengthening may vary depending on the thickness of the glass as shown in Table 1 below.

TABLE 1

| Cell | Depth (thickness) of chemical strengthening | | | | | |
|---|---|---|---|---|---|---|
| thickness | 5% | 10% | 15% | 20% | 30% | 40% |
| 30 μm | 1.5 μm | 3 μm | 4.5 μm | 6 μm | 9 μm | 12 μm |
| 50 μm | 2.5 μm | 5 μm | 7.5 μm | 10 μm | 15 μm | 20 μm |
| 70 μm | 3.5 μm | 7 μm | 10.5 μm | 14 μm | 21 μm | 28 μm |

The ion replacement solution used for the chemical strengthening may be a conventionally used ion replacement solution, and in one embodiment, may comprise potassium nitrate (KNO₃).

After the chemical strengthening process, a process for performing slow cooling and removing impurities may be additionally performed. The process for performing slow cooling and removing impurities may be a process that is commonly used, and in one embodiment, may comprise a washing process to remove impurities such as potassium nitrate after a process of performing natural slow cooling through a contact with outside air.

The chemical polishing step is polishing the ultrathin glass through a chemical polishing solution, and the chemical polishing step may be performed in terms of improving bending resistance so that the thickness of the ultrathin glass after chemical polishing becomes 80% or more and less than 100%, preferably 90% or more and less than 100%, of the thickness of the ultrathin glass before chemical polishing.

The chemical polishing solution is not particularly limited as long as it is typically used in a process of polishing an ultrathin glass, but may comprise one or more of hydrofluoric acid (HF) and ammonium fluoride (NH₄F).

Further, a cleaning step may be additionally performed if necessary after the chemical polishing step.

Hereinafter, the present disclosure will be described in more detail through Examples. However, the following Examples are provided to illustrate the present disclosure in more detail, and the scope of the present disclosure is not limited by the following Examples.

### PREPARATION EXAMPLE 1

### Preparation of Ultrathin Glass

An ultrathin glass was prepared by spraying an etchant having a composition comprising 20% by weight of hydrogen fluoride and 15% by weight of sulfuric acid on an aluminosilicate glass original plate having a thickness of 400 μm to etch it to 50 μm. The ultrathin glass original plate was cut into units of cells with a size of 70×160 mm² using a laser. The cut cells were stacked, and then immersed in the etchant having a composition comprising 20% by weight of hydrogen fluoride and 15% by weight of sulfuric acid to heal the glass side surface portion, and the healing-completed cell laminate was separated to prepare a final cell.

In order to perform chemical strengthening after cleaning the ultrathin glass, the cell was fixed to a strengthening jig, preheated in the air at 400° C. for 60 minutes, immersed in a potassium nitrate solution at 400° C. for 10 minutes, and then slowly cooled in the air, and cleaned to prepare a cell-unit ultrathin glass having a curved edge on the side surface thereof.

### PREPARATION EXAMPLES 2 TO 3

### Preparation of Compositions for Forming Coating Layer

Compositions for forming a coating layer were prepared by mixing the respective components in the compositions of Table 2 below.

TABLE 2
(Unit: % by weight)

| | Preparation | Preparation |
|---|---|---|
| Components | Example 2 | Example 3 |
| 2-(3,4-Epoxycyclohexyl) | 30 | 20 |
| ethyltrimethoxysilane | | |
| Isobornyl acrylate | 5 | 10 |
| 2-(Allyloxymethyl)acrylic acid | 15 | 15 |
| 3,4-Epoxycyclohexyl-3,4epoxycyclohexyl | 20 | 25 |
| carboxylate | | |
| Cyclohexanedimethanol diglycidyl ether | 20 | 25 |
| 3-Ethyl-3-[(2- | 10 | 5 |
| ethylhexyloxy)methyl]oxetane | | |

### EXAMPLES 1 TO 5

### Preparation of Ultrathin Glasses Comprising Coating Layer

Polyethylene terephthalate having a thickness of 100 μm was prepared as a first protective film 20, and the ultrathin glass 10 prepared in the Preparation Example 1 was attached to the pressure-sensitive adhesive surface of the first protective film, and the thickness is as shown in Table 3.

Thereafter, the first protective film 20 to which the ultrathin glass 10 has not been attached and the pressure-sensitive adhesive surface of the second protective film as described in Table 3 on the top surface of the ultrathin glass 10 are attached to the first protective film 20 and the ultrathin glass 10, and if there is no pressure-sensitive adhesive, an arbitrary surface is attached to the first protective film 20 and the ultrathin glass 10. At this time, the second protective film is attached by the pressure-sensitive adhesive surface of the first protective film 20.

A portion of the second protective film 30 attached on the first protective film 20 was cut with a UV Pico laser, and the separation distance d between the side surface of the ultrathin glass 10 and the cut surface of the second protective film is as described in Table 3.

A portion of the cut second protective film 30 that had been adhered to the top surface of the ultrathin glass 10 was peeled off, and it was peeled off by passing through an adhesive roller.

The compositions for forming a coating layer prepared in the Preparation Examples 2 to 4 were applied onto the second protective film 30 and the ultrathin glass 10 remaining after being cut and peeled off using spin coating. Thereafter, the ultrathin glass comprising a coating layer according to the present disclosure was prepared by curing the coating layer 40 by irradiating UV rays with a light quantity of 500 mJ/cm² under a general atmospheric environment using an ultraviolet irradiation device (mercury lamp).

Thereafter, the side surface of the coating layer 40 was cut with a UV Pico laser, and at this time, the width w from the side surface of the ultrathin glass 10 to the cut surface of the coating layer 40 was measured 5 times and indicated as an average value, and the width w and the difference between the maximum and the minimum values of the width w are as described in Tables 3 and 4.

Thereafter, the ultrathin glass 10 was peeled off from the first protective film 20 to obtain an ultrathin glass having a coating layer formed thereon.

### EXAMPLES 6 AND 7

### Preparation of Ultrathin Glasses Comprising Coating Layer

Ultrathin glasses comprising the coating layer were prepared in the same manner except that the first protective film 20 was peeled off without laser cutting the side surface after curing the coating layer 40 in the preparation methods of the Examples 1 to 5, and the ultrathin glasses were prepared according to the compositions and specifications shown in Table 3.

### COMPARATIVE EXAMPLES 1 TO 3

### Preparation of Ultrathin Glasses Comprising Coating Layer

Ultrathin glasses comprising the coating layer were prepared in the same manner except that the first protective film and/or the second protective film were not used in the preparation methods of the Examples 1 to 5, and the ultrathin glasses were prepared according to the compositions and specifications shown in Table 4.

### COMPARATIVE EXAMPLES 4 AND 5

### Preparation of Ultrathin Glasses Comprising Coating Layer

Ultrathin glasses comprising the coating layer were prepared in the same manner except that there was no separation distance d between the side surface of the ultrathin glass 10 and the cut surface of the second protective film in the preparation methods of the Examples 1 to 5, and the ultrathin glasses were prepared according to the compositions and specifications shown in Table 4.

### EXPERIMENTAL EXAMPLE

(1) Whether or not there are Contamination of Ultrathin Glass Rear Surface, Generation of Air Bubbles, and Poor Coating

With respect to the ultrathin glasses having a coating layer formed thereon through the Examples and the Comparative Examples, the rear surfaces of the ultrathin glasses were visually checked to confirm whether or not there were contamination of the rear surfaces, generation of air bubbles, and poor coating, due to the coating solution and foreign substances, and the results are shown in Tables 3 and 4.

(2) Evaluation of Handling Properties

With respect to the ultrathin glasses having a coating layer formed thereon through the Examples and the Comparative Examples, whether or not there were defects such as creases and bends of the first protective film occurring during the coating process and transport was visually checked, and the results are shown in Tables 3 and 4.

(3) Whether Coating Layer is Broken or not After First Protective Film is Peeled Off

With respect to the Examples in which the side surface of the coating layer was cut after the formation of the coating layer and the Comparative Examples in which the side surface of the coating layer was not cut, whether the coating layer was broken or not was observed through an optical microscope (MXG-2500REZ, ×250) after peeling off the first protective film, and the results are shown in Tables 3 and 4.

TABLE 3

| Items | | Example 1 | Example 2 | Example 3 | Example 4 | Example 5 | Example 6 | Example 7 |
|---|---|---|---|---|---|---|---|---|
| Second protective | Material | PET | PE | PET | PE | PE | PET | PE |
| film (Upper | Thickness (μm) | 38 | 30 | 100 | 30 | 30 | 75 | 30 |
| protective film) | Thickness of | 15 | — | 20 | — | — | 15 | — |
| | pressure-sensitive | | | | | | | |
| | adhesive (μm) | | | | | | | |
| | Total thickness | 53 | 30 | 120 | 30 | 30 | 90 | 30 |
| | (μm) | | | | | | | |
| | % to ultrathin | 76 | 60 | 120 | 43 | 60 | 129 | 30 |
| | glass thickness | | | | | | | |
| Ultrathin glass | Thickness (μm) | 70 | 50 | 100 | 70 | 50 | 70 | 100 |
| First protective | Material | PET | PET | PET | PET | PET | PET | PET |
| film (lower | Thickness (μm) | 75 | 100 | 100 | 100 | 100 | 100 | 100 |
| protective film) | Thickness of | 15 | 20 | 20 | 20 | 20 | 20 | 20 |
| | pressure-sensitive | | | | | | | |
| | adhesive (μm) | | | | | | | |
| | Total thickness | 90 | 120 | 120 | 120 | 120 | 120 | 120 |
| | (μm) | | | | | | | |

| Composition for forming a coating layer | Preparation | Preparation | Preparation | Preparation | Preparation | Preparation | Preparation |
|---|---|---|---|---|---|---|---|
| | Example 2 | Example 2 | Example 3 | Example 3 | Example 2 | Example 2 | Example 2 |
| Separation distance (d) (μm) | 70 | 70 | 50 | 230 | 300 | 70 | 70 |
| Side surface coating layer width (w) | 40 | 57 | 30 | 200 | 283 | 40 | 57 |
| (μm) | | | | | | | |
| Difference (μm) between the maximum | 18 | 24 | 12 | 41 | 51 | 115 | 126 |
| and minimum values of the side surface | | | | | | | |
| coating layer width (μm) | | | | | | | |
| Top surface coating layer thickness (μm) | 50 | 60 | 10 | 100 | 120 | 50 | 60 |
| Side surface coating layer thickness (t) | 115 | 107 | 100 | 163 | 160 | 115 | 107 |
| (μm) | | | | | | | |
| Ultrathin glass rear surface | None | None | None | None | Generation | None | None |
| contamination and poor coating | | | | | of air bubbles | | |
| Handling properties | Good | Good | Good | Good | Good | Good | Good |
| Whether the coating layer is broken or | No | No | No | No | No | No | No |
| not after the first protective film is peeled | breakage | breakage | breakage | breakage | breakage | breakage | breakage |
| off | | | | | | | |

TABLE 4

| | | Comparative | Comparative | Comparative | Comparative | Comparative |
|---|---|---|---|---|---|---|
| Items | | Example 1 | Example 2 | Example 3 | Example 4 | Example 5 |
| Second protective | Material | — | — | — | PET | PET |
| film (Upper | Thickness (μm) | — | — | — | 75 | 100 |
| protective film) | Thickness of | — | — | — | 15 | 20 |
| | pressure-sensitive | | | | | |
| | adhesive (μm) | | | | | |
| | Total thickness | — | — | — | 90 | 120 |
| | (μm) | | | | | |
| | % to ultrathin | — | — | — | 180 | 150 |
| | glass thickness | | | | | |
| Ultrathin glass | Thickness (μm) | 70 | 70 | 70 | 50 | 80 |
| First protective | Material | — | PET | PET | PET | PET |
| film (lower | Thickness (μm) | — | 38 | 70 | 100 | 100 |
| protective film) | Thickness of | — | 15 | 20 | 20 | 20 |
| | pressure-sensitive | | | | | |
| | adhesive (μm) | | | | | |
| | Total thickness | — | 53 | 90 | 120 | 120 |
| | (μm) | | | | | |

| Composition for forming a coating layer | Preparation | Preparation | Preparation | Preparation | Preparation |
|---|---|---|---|---|---|
| | Example 2 | Example 2 | Example 2 | Example 2 | Example 2 |
| Separation distance (d) (μm) | — | — | — | — | — |
| Side surface coating layer width (w) | 298 | 359 | 387 | — | — |
| (μm) | | | | | |
| Difference (μm) between the maximum | 62 | 88 | 87 | — | — |
| and minimum values of the side surface | | | | | |
| coating layer width (μm) | | | | | |
| Top surface coating layer thickness (μm) | 50 | 5 | 50 | 70 | 50 |
| Side surface coating layer thickness (t) | 120 | 65 | 115 | — | — |
| (μm) | | | | | |
| Ultrathin glass rear surface | Rear surface | None | None | Poor | Poor |
| contamination and poor coating | contamination | | | coating | coating |
| Handling properties | Poor | Poor | Good | Good | Good |
| | handling | handling | | | |
| Whether the coating layer is broken or | — | Breakage | Breakage | Breakage | Breakage |
| not after the first protective film is peeled | | | | | |
| off | | | | | |

As results of the above experiment, it could be confirmed in the case of Examples 1 to 4 of the present disclosure that the handling was excellent to facilitate the process, and the coating layer 40 was formed without rear surface contamination of the ultrathin glass 10 or poor coating thereof, and it could be confirmed in the case of Examples 1 to 5 that there was no breakage of the coating layer 40 even when, after the coating layer 40 was formed, the side surface of the coating layer 40 was cut, and the first protective film 20 was peeled off.

Meanwhile, in the case of Example 5, when the separation distance d between the side surface of the ultrathin glass 10 and the cut surface of the second protective film 30 was rather large, it was difficult to control the thickness t of the side surface coating layer 42, and the width w of the side surface coating layer 42 was wide so that a step was generated between the ultrathin glass 10 and the second protective film 30, and thus air bubbles were generated in the coating layer 40.

In the case of Examples 6 and 7, after the coating layer 40 was formed, the first protective film 20 was peeled off without cutting the side surface thereof by laser processing so that the cut surface of the side surface coating layer 42 was not smooth, and due to this, it could be seen that the difference between the maximum and minimum values of the width w was rather large.

On the other hand, in the case of Comparative Example 1 in which the first protective film 20 and the second protective film 30 were not attached, the rear surface of the ultrathin glass 10 was contaminated, and handling was also poor. It could be seen that handling was poor even when a too thin first protective film 20 was used without the second protective film 30 on the ultrathin glass 10.

Further, in the case of Comparative Examples 1 to 3 in which the second protective film 30 was not attached, it was impossible to control of the width w and thickness t of the side surface coating layer 42 of the ultrathin glass 10 when the composition for forming a coating layer is applied, and it could be seen that the width of the coating layer 40 was widened to the side surface of the ultrathin glass 10.

Meanwhile, in the case of Comparative Examples 4 and 5, when the composition for forming a coating layer was applied without a separation distance d between the side surface of the ultrathin glass 10 and the cut surface of the second protective film 30, it could be seen that the coating was poor and the side surface coating layer was not formed.

Further, in the case of Comparative Examples 2 to 5, when the first protective film was peeled off, the coating layer was broken to result in defects.

[Explanation of reference numerals]

| | |
|---|---|
| 10: Ultrathin glass | 20: First protective film |
| 30: Second protective film | 40: Coating layer |
| 41: Top surface coating layer | 42: Side surface coating layer |
| w: Width of side surface coating layer | t: Thickness of side surface |
| | coating layer |
| d: Separation distance between side | |
| surface of ultrathin glass and cut | |
| surface of second protective film | |

1. An ultrathin glass comprising a coating layer,
wherein the coating layer comprises a top surface coating layer formed on the top surface of the ultrathin glass and a side surface coating layer that is connected to the top surface coating layer and covers the side surface of the ultrathin glass.

2. The ultrathin glass of claim 1, wherein the top surface coating layer has a thickness of 5 to 150 μm, and the side surface coating layer has a thickness of 300 μm or less.

3. The ultrathin glass of claim 1, wherein the side surface coating layer has a width of 230 μm or less.

4. The ultrathin glass of claim 1, wherein the side surface coating layer has a difference between maximum and minimum widths of 100 μm or less.

5. The ultrathin glass of claim 1, wherein the side surface coating layer is formed to be spaced apart at a predetermined height from the lower end of the side surface of the ultrathin glass, and the predetermined height is within 10% of the thickness of the ultrathin glass.

6. The ultrathin glass of claim 1, wherein the ultrathin glass has a thickness of 20 to 150 μm.

7. The ultrathin glass of claim 1, wherein the ultrathin glass comprises one or more selected from the group consisting of alumino-borosilicate, borosilicate, alkali lead silicate, soda lime, lithium aluminosilicate, and aluminosilicate.

8. A method for preparing an ultrathin glass comprising a coating layer, the method comprising the steps of:
(a) attaching an ultrathin glass on a first protective film;
(b) attaching a second protective film on the first protective film to which the ultrathin glass has been attached;
(c) cutting the second protective film attached on the first protective film;
(d) peeling off the second protective film on the top portion of the ultrathin glass;
(e) forming a coating layer by applying and curing a composition for forming a coating layer on the ultrathin glass from which the second protective film has been peeled off; and
(f) peeling off the first protective film from the ultrathin glass.

9. The method of claim 8, further comprising a step of cutting the side surface of the coating layer formed in the step (e), between the steps (e) and (f).

10. The method of claim 9, wherein the side surface of the coating layer is cut through laser processing.

11. The method of claim 8, wherein in the step (c), the separation distance between the side surface of the ultrathin glass and the cut surface of the second protective film is 250 μm or less.

12. The method of claim 8, wherein in the step (f), the coating layer is cut so that the width from the side end of the ultrathin glass to the cut surface of the coating layer becomes 230 μm or less.

13. The method of claim 8, wherein the ultrathin glass has a thickness of 20 to 150 μm.

14. The method of claim 8, wherein the first protective film has a thickness of 20 to 210 μm.

15. The method of claim 8, wherein the thickness of the second protective film is 30 to 140% of the thickness of the ultrathin glass.

16. The method of claim 8, further comprising, before the step (a), the steps of:
preparing a plurality of cells by cutting an original ultrathin glass in cell units;
physically polishing the cut surface of the cell;
etching the polished cell; and
healing the polished cut surface of the cell.
